(19) United States
(12) Patent Application Publication
(10) Pub. No.: US 2012/0056749 A1
(43) Pub. Date: Mar. 8, 2012

(54) Vapor resistant tank level alarm system

(75) Inventor: Donald E. Smith, Huntington Beach, CA (US)

(73) Assignee: Tank Specialties, Inc.

(21) Appl. No.: 12/807,554

(22) Filed: Sep. 8, 2010

(51) Int. Cl. G08B 21/00

(52) U.S. Cl. 340/623

(57) ABSTRACT

A tank level alarm system in which all of the electrical components are located in a sealed housing above the tank's upper surface. There is no direct electrical connection between the tank liquid level detector within the tank interior and the alarm electrical components in the housing. A magnetic switch opens and closes based upon the proximity of a magnet mounted to a vertical rod to which a float is attached within the tank. The magnetic switch is positioned electronically in series with a battery and then in parallel with each of a plurality of alarm devices which in the preferred embodiment include a flashing light, an audio generator and a transmitter. When the tank's liquid level is below a selected maximum “safe” level, the magnet mounted to the upper end of a vertical rod is separated from the magnetic switch by a sufficient distance to keep the switch in its “open” state. However, as the liquid rises in the tank, the float connected to the lower end of the vertical rod, begins to rise with the liquid thereby causing the vertical rod to travel upwardly with the liquid. This raises the magnet positioned at the upper end of the rod until it comes sufficiently close to the magnetic switch to close it electronically, thereby connecting the battery to the alarm devices. A normally closed magnetic switch may be used with a chain or other flexible interconnector instead of a rod to serve as a low level alarm instead of a high level alarm.

### BACKGROUND OF THE INVENTION

1. Field of the Invention

The present invention relates to alarm systems deployed on top of tanks holding a liquid such as oil, to warn of impending overflow as the liquid rises in the tank interior. More specifically, the invention relates to such alarm systems wherein electronic portions thereof are isolated from the tank interior to prevent vapors or combustible gases from being inadvertently ignited by an electrical spark.

2. Background Art

Alarm systems designed to be mounted on top of closed tanks are known in the art. Such systems typically provide a level detector or other form of liquid sensor that extends into the upper portion of a tank used to store or transport a liquid such as oil, or gasoline or other corrosive or inflammable material. Normally, the detector or sensor is connected to one or more warning devices to alert personnel to a potentially dangerous condition where the contained liquid has risen within the tank to exceed a selected level that may indicate an imminent overflow of the liquid.

Such warning devices are for example, flashing lights, loud audio generators such as buzzers, bells or sirens, and even electrical transmitters operating at frequencies that are compatible with matching receivers to alert personnel in nearby buildings or vehicles and the like.

Typically, the alarm systems are mounted to the top surface of such tanks and have the level detector extending through the top surface into the tank interior. The alarm warning devices will, of course, remain above the tank top surface so that the triggered light or audio signal can be readily seen or heard by nearby personnel whenever the liquid level has increased beyond the selected upper threshold. Even when the warning device is a transmitter, it is preferably located on top of the tank where the tank material will not interfere with the transmission of an alarm signal to nearby receivers.

A significant concern stemming from the use of electronics in such alarms, is the risk of an explosion or flash fire due to the combustibility of the liquid or from vapors formed from the liquid and that might come in contact with an electronic spark and the like. Even in those conventional alarm systems where all of the electronics may be located above the tank upper surface, there is normally an open path from the interior of the tank where the level detector or sensor is positioned, to the electronic devices above the tank. Consequently, there is a risk of fire or explosion which could be catastrophic and lead to destruction of the entire tank as well as adjacent tanks with attendant risk of injury and death to nearby personnel.

Therefore, it would be highly advantageous if it were possible to design such alarm systems so that the liquid level detecting portion thereof and the electronic portion, were isolated from each other so that the risk of vapor combustion could be reduced significantly or even made to be essentially zero.

### SUMMARY OF THE INVENTION

The present invention comprises a vapor resistant tank level alarm system in which all of the electrical components are located in a sealed housing above the tank's upper surface. Moreover, uniquely in the present invention, there is no direct electrical connection between the tank liquid level detector within the tank interior and any of the alarm electrical components in the body. This unique isolation is made possible in a preferred embodiment, by employing a normally open magnetic switch that opens and closes based upon the proximity of a magnet mounted to the vertical rod to which a level detector is attached within the tank. The magnetic switch is positioned electronically in series with a battery and then in parallel with each of a plurality of alarm devices which in the preferred embodiment include a flashing light, an audio generator and a transmitter. When the tank's liquid level is below a selected maximum “safe” level, the magnet mounted to the upper end of a vertical rod is separated from the magnetic switch by a sufficient distance to keep the switch in its “open” state. Therefore, the battery in the housing is disconnected from all of the alarm devices. However, as the liquid rises in the tank, liquid floats connected to the lower end of the vertical rod, begin to rise with the liquid thereby causing the vertical rod to travel upwardly with the liquid. This travel raises the magnet positioned at the upper end of the rod until it comes sufficiently close to the magnetic switch to close it electronically, thereby connecting the battery to the alarm devices and alerting personnel of the rising liquid. A test switch is connected across the magnetic switch to permit personnel to check on the functionality of the alarm devices. In an alternative embodiment, the invention is implemented with a normally closed magnetic switch and a chain (instead of a normally open switch and a rod). This embodiment is used to provide an alarm when the level of liquid in a tank becomes too low (rather than too high) and the float pulls the chain which withdraws a magnetic from adjacent the magnetic switch. Since the magnetic switch in this embodiment is normally closed, pulling the magnet away from the magnetic switch, will complete the circuit and activate the alarm devices to indicate a liquid level that is too low.

The preferred embodiment hereof has been successfully tested in an Explosive Atmosphere Test according to Military Standard MIL-STD-810E, method 511.3, Procedure I.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a fully assembled preferred embodiment of the invention;

FIG. 2 is similar view showing the float and vertical rod portion thereof partially disassembled;

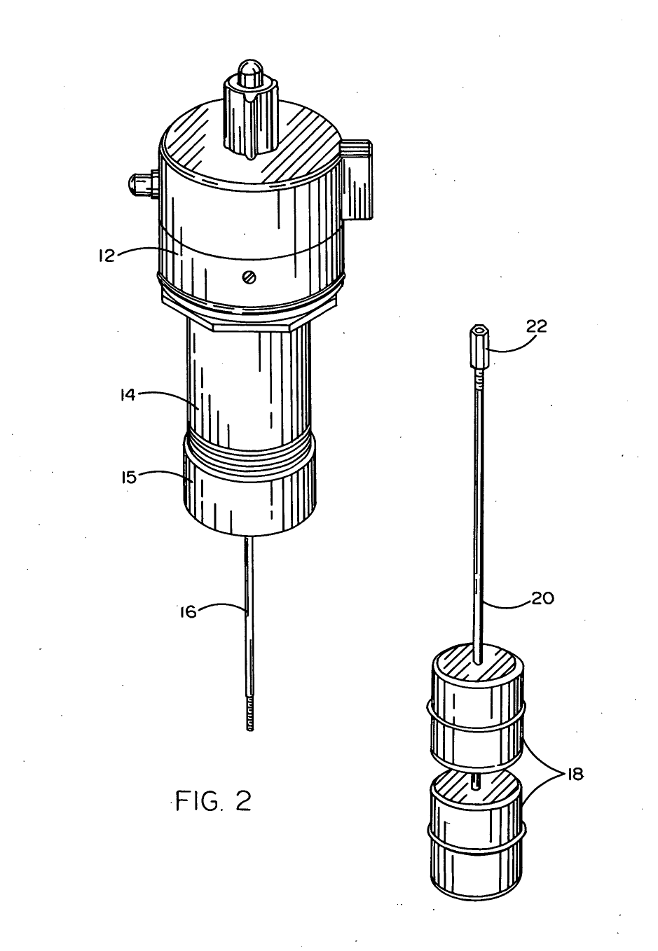

FIG. 3 is a plan view of the body and upper vertical rod portion of the invention;

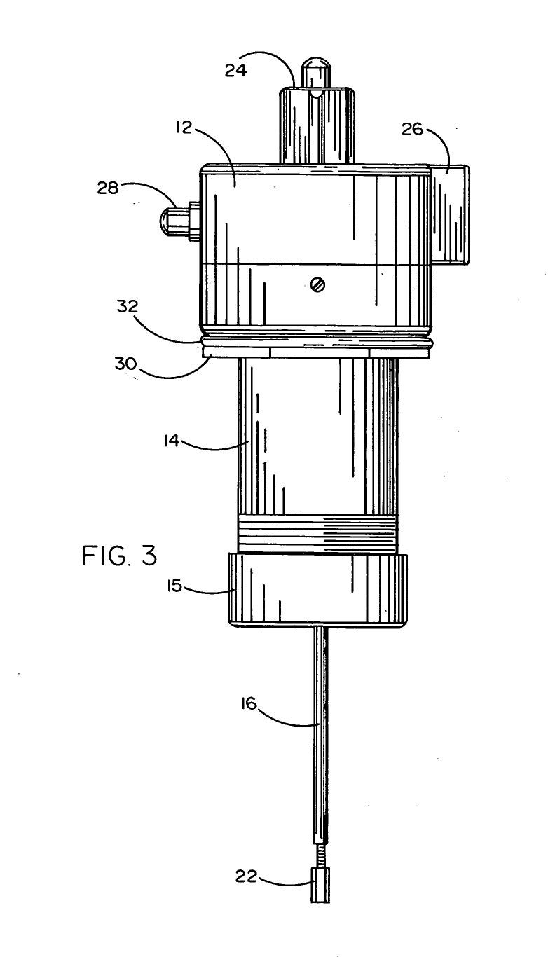

FIG. 4 is a partially exploded view of the body and upper vertical rod portions of FIG. 3; and

FIG. 5 is a schematic/block diagram representation of the preferred embodiment.

### DETAILED DESCRIPTION OF A PREFERRED EMBODIMENT

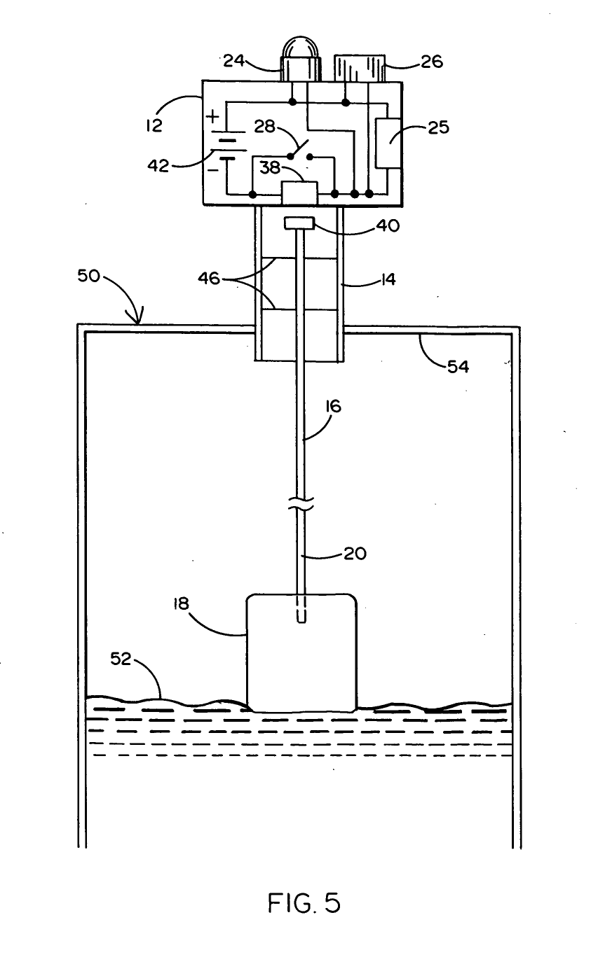

Referring now to the accompanying figures, it will be seen that a preferred embodiment of a tank level alarm system 10 comprises an upper body 12, a lower body 14, an upper rod portion 16, a lower rod portion 10 and a float 18. A coupler 22 provides for coupling the upper and lower rod portions co-axially to form one continuous vertical rod connecting the float to the lower body 14. As seen best in FIG. 5, float 18 rides on the surface of liquid 52 contained in an enclosed tank 50 covered by a top surface 54. The float is preferably Teflon-coated to resist liquid and/or solid adherence to the float of any material which could otherwise alter the floatation characteristics of the float.

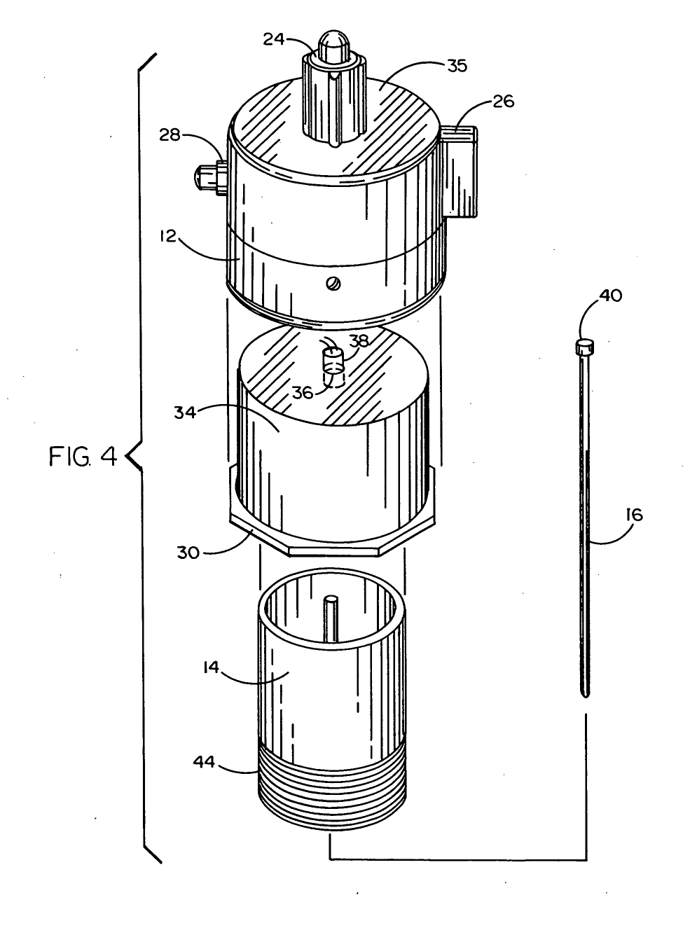

The upper body 12 forms a sealed chamber that houses all of the electronics which comprises a battery 42, a magnetic switch 38, and the alarm devices consisting of a flashing light assembly 24, a piezo audio buzzer 26 and an alarm signal transmitter 25. In addition, a test switch 28 is connected across the magnetic switch 38 to enable convenient testing of the alarm devices. The battery and magnetic switch are connected in series and are, in turn, connected in parallel with each of the alarm devices. As seen best in FIG. 4, the upper body 12 comprises a plastic outer member 35 and a plastic inner member 34. Inner member 34 has an aperture 36 which holds the magnetic switch 38 in sealed engagement with the switch's wires extending into the outer member 35. A flange 30 and an O-ring 32 assure a firm sealed interface between the members 34 and 35.

As seen further in FIG. 4, a magnet 40 is positioned at the upper end of rod 16 where it will be in proximity to magnetic switch 38 when the rod 16 is forced upwardly by float 18 on the surface of rising liquid 52 in tank 50. As the rod 16 transits in an upward direction along an axis from a rising liquid level, magnet 40 will eventually be positioned sufficiently close to magnetic switch 38 to close the magnetic switch thereby connecting battery 42 across each of the alarm devices to alert nearby personnel that the liquid in the tank has risen to the maximum level selected for alarm purposes. Magnetic switches of the type disclosed herein are commonly found in burglar alarm systems to detect whether windows or doors have been opened. When the liquid level is reduced within the tank, rod 16 will travel in a downward direction as float 18 follows the surface of the liquid. As the magnet 40 becomes sufficiently separated from magnetic switch 38, the latter will open electrically and thus disconnect the battery from the alarm devices.

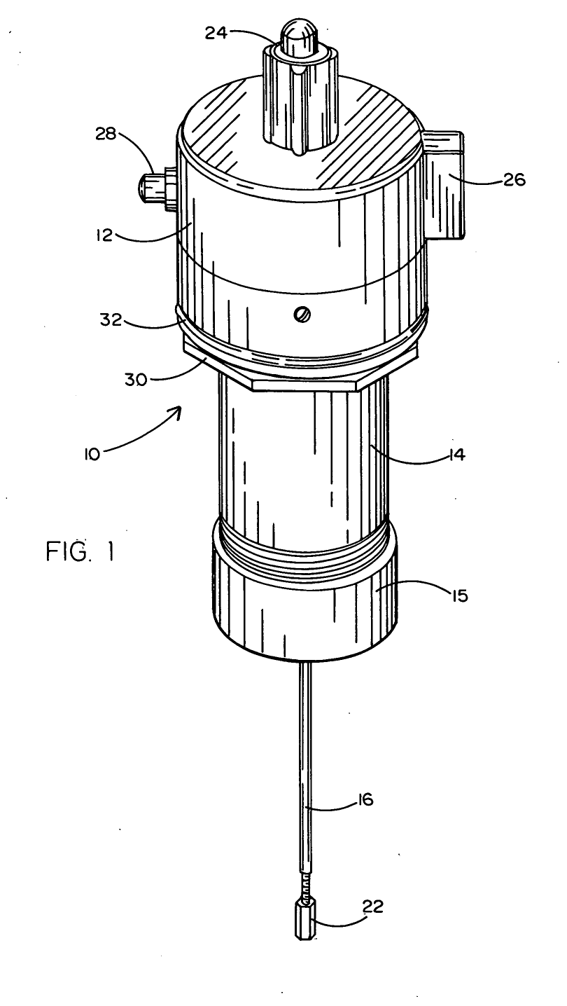

Lower body 14 comprises a section of hollow steel pipe threaded at its lower end 44 to mate mechanically with a matching threaded aperture in the top surface 54 of tank 50. This threaded end 44 is shown in FIG. 1 as being covered by a removable plastic cap 15 designed to protect the threads so that they can be mated in reliable sealing engagement with the tank wherein rods 16 and 20 can be adjusted in combined length to place the float 18 at the liquid surface and establish the level of the liquid which would set off the alarm devices. A pair of spacer plates 46 (shown schematically in FIG. 5), guides the rod 16 so that it remains vertical throughout its range of travel.

It will now be apparent that the present invention provides a novel alarm system for use on liquid storing tanks to alert nearby personnel if the liquid rises above a selected level within the tank. The preferred embodiment disclosed herein provides a unique magnet/magnetic switch combination which permits isolation of the battery and the alarm's electrical circuit from the liquid in the tank and from any vapor that may be formed from that liquid to significantly reduce the risk of combustion thereof. In an alternative embodiment, the normally open magnetic switch is replaced with a normally closed version and the rod is replaced with a long chain having a magnet at its upper end. The chain is long enough to remain slack until the liquid falls below a minimum height inside the tank. Then the chain will follow the float and pull the magnet away from the magnetic switch to activate the alarm devices. Those having skill in the arts relevant to the invention will now perceive various modifications, variations and improvements based upon the teaching herein. Therefore, the scope hereof is not to be deemed limited by the disclosed embodiment, but only by the claims appended hereto and their legal equivalents.

I claim:

1. An alarm system for warning that a liquid in an enclosed tank has risen above a selected level, the system being configured for installation on top of the tank and having at least one warning device for alerting nearby personnel; the system comprising:
a moveable member having a lower end extending into said tank and being connected to a float that is buoyant in said liquid so that change in the location of the surface of said liquid will produce a corresponding change in the position of said moveable member, said moveable member having an upper end extending above said top of said tank and being connected to a magnet;
a body enclosing a circuit having a battery, a magnetic switch and at least one electrically operated warning device, said magnetic switch being connected to said battery for selective activation of said at least one warning device depending upon the proximity of said magnet to said magnetic switch;
said body being located above said top of said tank and providing a sealed chamber that isolates said circuit from said moveable member to reduce the risk of inadvertent combustion of said liquid or vapor thereof.

2. The alarm system recited in claim 1 said moveable member being moveable along an axis, said body being positioned relative to said moveable member so that said magnetic switch and said magnet both reside along said axis.

3. The alarm system recited in claim 1 wherein said warning device comprises at least one of a flashing light, a sound generator and an electrical signal transmitter.

4. The alarm system recited in claim 1 further comprising a test switch connected in parallel with said magnetic switch, said test switch being mechanically accessible at said body for selectively assessing the operational status of said warning device.

5. The alarm system recited in claim 1 wherein said float is coated with an adherence-resistant material.

6. The alarm system recited in claim 2 wherein said moveable member is restrained from lateral movement by at least one spacer plate so that said moveable member can move only along said axis.

7. The alarm system recited in claim 1 wherein said body comprises an upper body portion and a lower body portion, said upper body portion being made of a non-conductive material and said lower body portion being made of a conductive material.

8. The alarm system recited in claim 7 wherein said lower body portion comprises a threaded metal pipe having at least a partially threaded exterior for threaded engagement with an aperture through said top of said tank.

9. An alarm system for mounting on top of an enclosed tank and providing a moveable float for monitoring the level of a liquid stored in said tank; the system comprising:
a magnet interconnected to said float for movement therewith in response to a change in the level of said liquid within said tank;
at least one alarm device for alerting personnel when said level of said liquid differs from a selected height within said tank;
said alarm device being connected to a source of power through a magnetic switch positioned in proximity to said magnet for responding to the relative distance between said magnet and said magnetic switch by opening or closing depending upon said distance.

10. The alarm system recited in claim 9 further comprising an enclosure isolating said power source from said liquid.

11. The alarm system recited in claim 9 wherein said magnetic switch is a normally open switch and wherein said magnet and said float are interconnected by a rod.

12. The alarm system recited in claim 9 wherein said magnetic switch is a normally closed switch and wherein said magnet and said float are interconnected by a chain.
